(19) United States
(12) Patent Application Publication
(10) Pub. No.: US 2024/0318002 A1
(43) Pub. Date: Sep. 26, 2024

(54) PROCESS FOR THE PREPARATION OF HIGHER-GRADE VG BITUMENS USING SULFUR-BASED POLYMERIC ADDITIVES (SBPA)

(71) Applicant: Council of Scientific & Industrial Research, New Delhi (IN)

(72) Inventors: Thangaraj Senthilkumar, Dehradun (IN); Kamal Kumar, Dehradun (IN); Amod Kumar, Dehradun (IN); Vedant Joshi, Dehradun (IN); Umesh Kumar, Dehradun (IN); Sudip Kumar Ganguly, Dehradun (IN); Manoj Thapliyal, Dehradun (IN); Manoj Srivastava, Dehradun (IN); Anjan Ray, Dehradun (IN)

(21) Appl. No.: 18/612,469

(22) Filed: Mar. 21, 2024

(30) Foreign Application Priority Data
Mar. 22, 2023 (IN) 202311020225

(51) Int. Cl. C08L 95/00; C10C 3/00

(52) U.S. Cl. CPC C08L 95/00; C10C 3/00; C08L 2555/80

(57) ABSTRACT

Higher grade VG bitumens are prepared particularly by blending of 0.1 to 20 wt % specific Sulfur-Based Polymeric Additives (SBPA) having MW 1,000 to 10,000 Dalton. The prepared higher grade VG bitumens have Kinematic Viscosity of from 200 cSt to 1000 cSt measured at 135° C. from Base bitumen (VG10) at a temperature from 100° C. to 140° C. and stirring in the range of 800 rpm to 1200 rpm for 30 minutes to 90 minutes for improving the properties of bitumens and to make higher grades of Bitumens (VG20, VG30, VG40) for industrial applications.

### CROSS-REFERENCES TO RELATED APPLICATIONS

This application claims benefit of priority under 35 U.S.C. § 119(a)-(d) to Indian patent application Ser. No. 20/231,1020225, filed Mar. 22, 2023, and hereby incorporated herein by reference in its entirety.

### TECHNICAL FIELD

This application relates to a process for the preparation of higher-grade VG bitumens, by blending Sulfur-Based Polymeric Additives (SBPA). Particularly, this application relates to a process to make higher grades of Bitumens such as VG20, VG30, and VG40 for industrial applications such as road paving, roofing, ceiling joints, etc. or civil construction mixture used for roofs, beams, pillars, floors, and roads.

### BACKGROUND

‘Bitumen’ or ‘Asphalt’ is a complex mixture of essentially different hydrocarbons (paraffinic, naphthenic, and aromatic). It contains a small amount of sulfur, nitrogen, and oxygen, along with trace quantities of metals such as vanadium, nickel, iron, magnesium, calcium, etc. The typical chemical composition of bitumen comprises Carbon (82-88%), Hydrogen (8-11%), Sulfur (0-6%), Oxygen (0-1.5%), and Nitrogen (0-1%). Bitumen is derived from petroleum either from natural phenomena or by petroleum refining processes. It is a black or dark brown amorphous solid and is composed principally of high molecular weight hydrocarbons having adhesive properties. It is thermoplastic in nature, within specific temperature ranges, which may vary by grade of bitumen, and viscoelastic in nature.

Bitumen is generally produced from the bottom-of-the-crude oil barrel. Bitumen is prepared from vacuum residue obtained by crude oil distillation. Two main approaches are followed to prepare on-grade bitumen (upgraded bitumen from base bitumen i.e., VG10 to VG20, 30 and 40), such as ‘Air-blowing’ and Mixing of ‘Additives’ or ‘Polymers’ into the vacuum residues or base bitumens. Based on the selection of approaches, bitumen is classified into ‘Viscosity Grade (VG)’ and ‘Modified Bitumen,’ respectively.

Bitumen is widely used for laying pavements, waterproofing, and structural applications. It finds application as a binder for making roads, highways, runways, and parking areas. Bitumen is also used for other applications, such as paints, inks, coatings, batteries, electrical cables, and other electrical products. It can also be used to protect building structures as a waterproofing material or to mitigate corrosion. Higher VG grade bitumens (e.g., VG40) generally have little or no elasticity due to high viscosity. Due to this inherent property, coatings or pavement layers comprised of bitumen are brittle and harder at low temperatures whereas, are softer and pliable at higher temperatures. Therefore, various additives/modifiers particularly polymers are used to improve its rheological properties such as complex modulus, storage modulus, and loss modulus with respect to temperature.

Roads made from polymer-modified bitumens are more stable under heavy loads and braking, and show increased resistance to permanent deformation in hot weather (rutting) and cracking in cold weather (fatigue). Further, such roads exhibit better adhesion between aggregates and binders. Common additives/modifiers for improving the bitumen properties are Sulfur, Natural Rubber, Crumb Rubber from discarded tyres, Styrene-butadiene-Styrene (SBS), Ethylene Vinyl Acetate (EVA), Polypropylene, etc. The selection of a polymer for improving the properties of bitumen is very important. The polymer should be compatible with base bitumen, able to melt and disperse in bitumen, able to resist degradation of bitumen at mixing temperatures, capable of being processed by conventional mixing lying machinery, produce coating viscosity at application temperature, maintain premium properties of bitumen during storage, application and in service and just as importantly should be cost-effective.

Several patents report using peroxides and sulfur as coupling agents for making bitumen compositions. U.S. Pat. Nos. 3,634,293 and 4,503,176 relate to a process for making polymer-bitumen compositions using peroxides. Peroxides are generally expensive and highly reactive. Because of their reactivity, they can adversely affect the composition of the polymer-bitumen blend and its properties and involve hazardous storage and transport. U.S. Pat. Nos. 3,634,293, 5,120,777 and 4,154,710, British Patent 2,025,986, European Patent Nos. 0360656A and 0096638B1 relate to the use of sulfur for making bitumen. In the latter three documents, the sulfur source may be a compound that acts as a sulfur donor or agent which yields free elemental or radical sulfur during the polymer-modified bitumen preparation process. Such sulfur sources include various dialkyl disulfides and diaryl disulfides, thiuram disulfides (R₂NCSS)₂, and amino disulfides. Some of these are known as vulcanization agents (morpholino disulfide and polyalkyl phenol disulfides) and vulcanization accelerators.

Many disclosures require free sulfur during the blending process to give rise to the coupling necessary for homogenization and storage stability. Free sulfur is a less expensive alternative to these sulfur sources. Still, it is not always efficient (with some blends, homogenization does not occur, with others, gelation can be a severe problem). Most importantly, sulfides and disulfides lead to toxic and environmentally hazardous hydrogen sulfide formation at elevated temperatures in the blending process. It has also been observed that if free (elemental) sulfur is blended with the base bitumen, after 4 to 5 days, some sulfur leaches out to the bitumen surface and may be subsequently released into the atmosphere (as hydrogen sulfide or other potentially harmful molecules) thereby indicating risks of elemental sulfur use in this application.

References may be made to patent CA1260653, which discloses modified asphalts compositions for use as roofing materials with low viscosity at elevated processing temperatures, which retain their mechanical properties at 200° C. temperatures. Adding 2 to 10% of bis-stearoylamide helps in reducing the viscosity of a bituminous composition of full-blown and partially oxidized bitumen (having lower viscosity) for roofing applications.

References may be made to patent application WO2009013339, which discloses polymers (SBS; Styrene-Isoprene-Styrene; EVA) modified bitumen composition. The composition comprises bitumen, polymer and a compatibilizing agent (prepared by reacting one or more unsaturated monomers). The polymer-modified bitumens contain said polymers preferably in the range of 1 wt % to 25 wt % and more preferably below 15 wt %. Polymer-modified bitumen provides a 10% increase in viscosity and softening point up to 20%.

References may be made to patent U.S. Pat. No. 8,851,332, which discloses a polymer-modified bitumen (PMB) compound for the bituminous covering layer of a roof sheet, predominantly including a distillate bitumen that may contain a synthetic elastomeric rubber filler in the form of SBS in a certain amount which modifies the elastic properties of the bitumen. Bitumen, as such, is a semi-solid viscous liquid consisting of a mixture of hydrocarbons and their derivatives. Hence, along with these properties, bitumen is compatible with other aggregates resulting in high-quality asphalt/bitumen. Additive modified bitumen provides solubility in trichloroethylene by 98%, increases viscosity by up to 250%, increases in flash point by up to 150%, increases in softening by up to 35%, and decreases in penetration by up to 100%.

References may be made to patent application JP10182981A, which discloses a composition that can prevent a water-proof asphalt layer-applicable as an asphalt roofing material —from being deteriorated by alkaline water. This composition contains an acid organophosphate with a P-OH radical comprising a long-chain hydrocarbon intramolecular group in the ratio of 0.1 to 5 wt % relative to the asphalt composition. The composition also contains an inorganic phosphorus compound, for example, chosen from Phosphorus Pentoxide (P₂O₅), Polyphosphoric Acid, Phosphorus Pentasulfide (P₂S₅), Oxyphosphorustrichloride (POCl₃), and Phosphorus Trichloride (PCl₃) in a ratio of 0.075 to 5 wt % relative to the asphalt composition. According to this disclosure, a fiber sheet saturated with an asphalt composition containing a blend of an acid organophosphate and an inorganic phosphorus compound leads to an asphalt system roofing material degradation, which by alkaline moisture can be prevented. However, it is currently known within the asphalt binder industry that inorganic phosphorus compounds tend to increase the viscosity of an asphalt binder. Such effects are also described in a research reference, “Energy and Fuels' vol 22, pages 2637-2640 (2008) by J. F. Masson.

References may be made to Journal “IOSR Journal of Mechanical and Civil Engineering 13, 120-128 (2016)” wherein authors studied the EVA polymer-modified bitumen used for road paving applications. The effect of EVA on bitumen (60/70 grade) was observed to decrease penetration and ductility values and increase viscosity and softening points with increasing polymer content. The softening point temperature is favorable since bitumen with a higher softening point may be less susceptible to permanent deformation (rutting).

References may be made to Journal “Civil Engineering, vol 2016 (2016) Article ID 5938270”, wherein Saboo et al. elaborated on elastomeric SBS and plastomeric EVA-modified VG10 and VG30 bitumen. The results found that elastomeric modified binder and mixes gave the best performance in terms of fatigue outcome. Plastomeric modification was highly susceptible to stress, resulting in poor fatigue performance at lower temperatures. Fatigue life increases with an increase in temperature of 10-30° C. for all the binders. The increase in fatigue life with increased temperature was the highest for VG10, indicating higher temperature susceptibility for this grade.

References may be made to Journal “Materials and Design 62, 91-97 (2014)”, wherein Munera et al. demonstrated the preparation of multi-component polymer-bitumen blends (MC) based on an 80/100 penetration grade bitumen with varying amounts of (i) Polyethylene Wax (PW); (ii) Styrene-Butadiene-Styrene copolymer (SBS); and (iii) Crumb Rubber (CR).

References may be made to Journal “Journal of Industrial and Engineering Chemistry 44, 112-117 (2016)”, wherein Kumar et al., reported the preparation of SBS modified bitumen with addition of 0.5 to 1.0 wt % of SBS to 80/100 base bitumen to form PG-58 and PG-64 bitumens. Experimental results showed that the complex modulus of PG-58 at 58° C. & 64° C. is increased to 1.20 and 3.02 times, respectively, by adding 0.5 wt % SBS to 60/70 base bitumen. Similarly, the complex modulus of PG-64 at 58° C. and 64° C. is increased to 3.47 and 13.7 times, respectively, by adding 1.0 wt % SBS to 80/100 base bitumen.

In some disclosures, the properties of bitumens are improved by adding either hydrocarbon polymers or limited-sulfur-content polymers like crumb rubber. But polymers are generally expensive and suffer insolubility and phase separation problems during storage of modified bitumen. On the other hand, elemental sulfur, though an inexpensive alternative, cause hazardous Hydrogen Sulfide (H₂S) formation at the elevated temperature of the blending process or during leaching over time. Considering the disadvantages of using individual polymers and elemental sulfur for improving the properties of bitumen, in the present patent, a new class of polymer was used to improve the properties of base bitumen and to make higher-grade bitumens. This new class of polymer is derived from petroleum sources which are compatible with petroleum-derived base bitumens and will minimize phase separation problems.

Further, this new class of SBPA is a by-product of a unique desulfurization process of crude oil and petroleum refinery streams synthesized by using the methodology given in patent application IN202111061088. This patent application also provides the opportunity for value addition of the synthesized sulfur-polymer for making higher Viscosity Grade Bitumens. None of the documents referred above discloses the use of polymeric sulfur materials as a compatibilizer/additive for polymer-bitumen blends except as a source of free sulfur to act as a conventional coupling agent in the blending process. Additionally, meeting a higher specific VG bitumen with low dosage levels (<8 wt %) is crucial in terms of the cost and mechanical properties of the bitumen. Therefore, there is a considerable demand for developing a new additive that works at a low dosage limit of ≤5 wt % to improve VG bitumen characteristics.

Accordingly, the present disclosure provides a method for making higher VG bitumen using Sulfur-Based Polymeric Additives (SBPA) to improve the bituminous composition's storage stability.

Yet another objective of the present disclosure is the preparation of bitumens to meet the properties of VG20, VG30, and VG40 from VG10 by blending suitable amounts of SBPA.

### BRIEF DESCRIPTION OF THE DRAWINGS

FIG. 1 is graphical representation of the effect of concentration of SBPA (from high sulfur LCO refinery stream) on the fundamental properties of higher-grade VG bitumen.

FIG. 2 is graphical representation of PI Vs. Effect of concentration of SBPA (from high sulfur LCO refinery stream) in higher grade VG bitumen.

FIG. 3 represents 1H NMR of SBPA from (high sulfur LCO) and high sulfur LCO refinery streams.

FIG. 4 represents FT-IR of SBPA from high sulfur LCO refinery streams.

FIG. 5 represents absorption spectrum of SBPA from high sulfur LCO and high sulfur LCO refinery streams.

FIG. 6 represents TGA and DTA of SBPA from high sulfur LCO refinery streams.

### SUMMARY

This disclosure provides processes for preparing higher-grade VG bitumens with a new approach with improved properties.

This disclosure provides also methods preparing higher VG bitumen using Sulfur-Based Polymeric Additive (SBPA) synthesized from crude oil and petroleum fractions such as LCO, LCGO, and HGO. The crude oils should have API gravity in the range of 10 to 40, particularly in the range of 20 to 30.

This disclosure provides routes to improve the VG bitumen characteristics by varying dosage levels of SBPA from 0.1 to 20 wt %, particularly from 0.5 to 10 wt % and more particularly from 0.5 to 5 wt %.

This disclosure provides preparations of higher VG bitumens, including VG20, VG30, and VG40 from VG10, by blending Sulfur-Based Polymeric Additives (SBPA).

Accordingly, the present disclosure provides a process for the preparation of higher-grade VG bitumens (VG20, VG30, VG40) comprising blending 80-99.90 wt % base bitumen and 0.1-20 wt % Sulfur-Based Polymeric Additives (SBPA) at a temperature in the range of 100 to 140° C. with stirring in the range of 800 to 1200 rpm for a time period ranging between 30 minutes to 90 minutes followed by chilling at room temperature in the range of 15 to 25° C. for a period in the range of 12 to 24 hrs to obtain higher grades VG bitumens.

In an embodiment of the present invention, the base bitumen used is VG10 bitumen or bitumen having similar properties from petroleum origin.

In another embodiment of the present invention, the Sulfur-Based Polymeric Additives (SBPA) used is poly(thiophene-co-benzothiophene-co-dibenzothiophene) copolymers or sulfur-containing heterocyclic aromatics compounds.

In yet another embodiment of the present invention, the Sulfur-Based Polymeric Additives (SBPA) used is derived from crude oils and petroleum fractions like LCO, LCGO, and HGO in the form of viscous liquid to semi-solid.

In yet another embodiment of the present invention, Sulfur-Based Polymeric Additive (SBPA) is in the range of 0.1 to 20 wt % based on the total weight of the VG bitumen.

In yet another embodiment of the present invention, Sulfur-Based Polymeric Additive (SBPA) have molecular weight ranging between 1,000-10,000 Dalton and KV of higher-grade bitumen in the range of 200-1000 cSt measured at 135° C.

### DETAILED DESCRIPTION

The present disclosure provides a process for the preparation of higher-grade VG bitumens using Sulfur-Based Polymeric Additives (SBPA), when used in bitumen mixtures, markedly improves the elastic properties (measured, e.g., as elastic restoration) of bitumen while also meeting the other necessary criteria satisfied by known additives, such as high thermal stability, oxidation resistance, and compatibility.

Higher-grade VG bitumen is prepared by blending 0.1 to 20 wt % of an SBPA in bitumens, said polymeric additive being comprised of various polymers from petroleum crude oils and refinery streams.

The higher-grade VG bitumens meet the properties such as PEN, SP, KV, and PI of VG20, VG30, and VG40 bitumen. PEN, SP, KV, and PI are the important standard tests for bitumen quality/grade, as these are used to decide the grade of the bitumen. The obtained higher-grade VG bitumen can be used as industrial bitumen for road paving, roofing or ceiling joints, etc., or civil construction mixtures used for roofs, beams, pillars, floors, roads, etc.

The present disclosure relates to a process for the preparation of higher-grade VG bitumens, by blending specific types of poly(thiophene-co-benzothiophene-co-dibenzothiophene) co-polymers-SBPA-in the range of 0.1 to 20 wt % based on the total weight of the VG bitumen having MW 1,000 to 10,000 Dalton and Kinematic Viscosity in the range of 200 to 1000 cSt measured at 135° C.—as an additive in Base bitumen (VG10) at a temperature in the range of 100 to 140° C. and stirring in the range of 800 to 1200 rpm for a time period of 30 to 90 minutes for improving the properties of base bitumen and to make higher grades of Bitumens such as VG20, VG30, and VG40 for industrial applications such as road paving, roofing, ceiling joints, etc. or civil construction mixture used for roofs, beams, pillars, floors, and roads.

This method provides a series of industrial bitumen compositions with varying compositional ratios of at least one such specific SBPA blended into base bitumen grade VG10 to make a higher grade of bitumens, i.e., VG20, VG30, and VG40.

SBPA is used from different crude oils and refinery streams, particularly crude oil of API-26, and refinery streams such as LCO, LCGO, and HGO but not limited to these.

The following properties of the VG10 bitumen, such as penetration (PEN), softening point (SP), kinematic viscosity (KV), and penetration index (PI) has been improved to make higher VG bitumens.

The improved grades of bitumen (VG20, VG30, and VG40) prepared by blending VG10 and SBPA was further blended with crumb rubber at a temperature ranging from 120-170° C. and blending ratio from 0.1 to 5 wt %. Still, it deteriorated the properties of the SBPA blended bitumen in terms of PEN, SP, and KV, indicating that the addition of crumb rubber as a second polymer did not show any improvement in the properties of higher grades of bitumen.

The improved grades of bitumen (VG20, VG30, and VG40) prepared by blending VG10 and SBPA were further blended with SBS at a temperature ranging from 120-170° C. and blending ratio from 0.1 to 5 wt %. Still, it deteriorated the properties of the SBPA blended bitumen in terms of PEN, SP, and KV, indicating that the addition of SBS as a second polymer did not show any improvement in the properties of higher grades of bitumen.

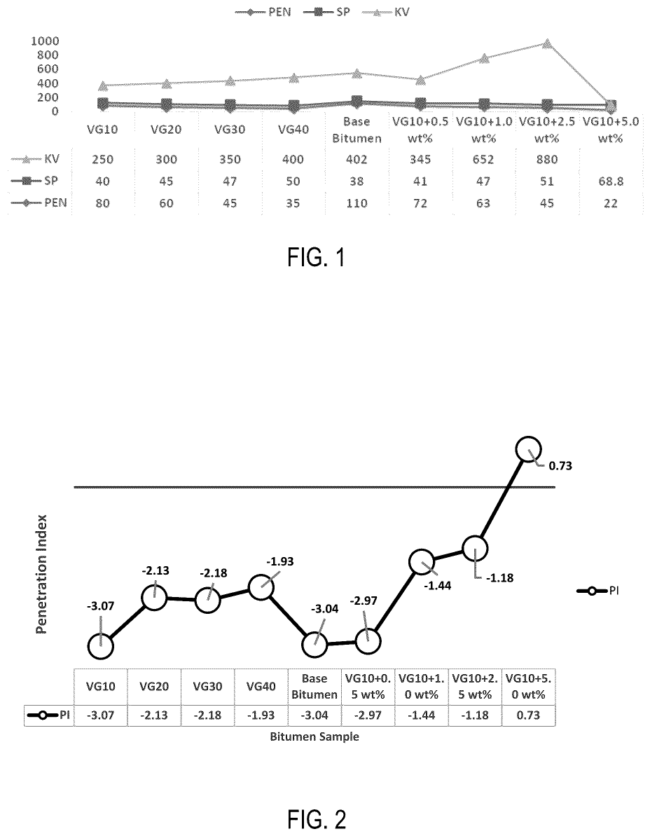

Embodiments herein include the preparation of higher-grade VG bitumen and the evaluation of different properties is given in FIGS. 1 and 2.

### Characterization of the SBPA Additive

SBPA as described in this disclosure is prepared by the process as mentioned in previous patent application no. IN202111061088.

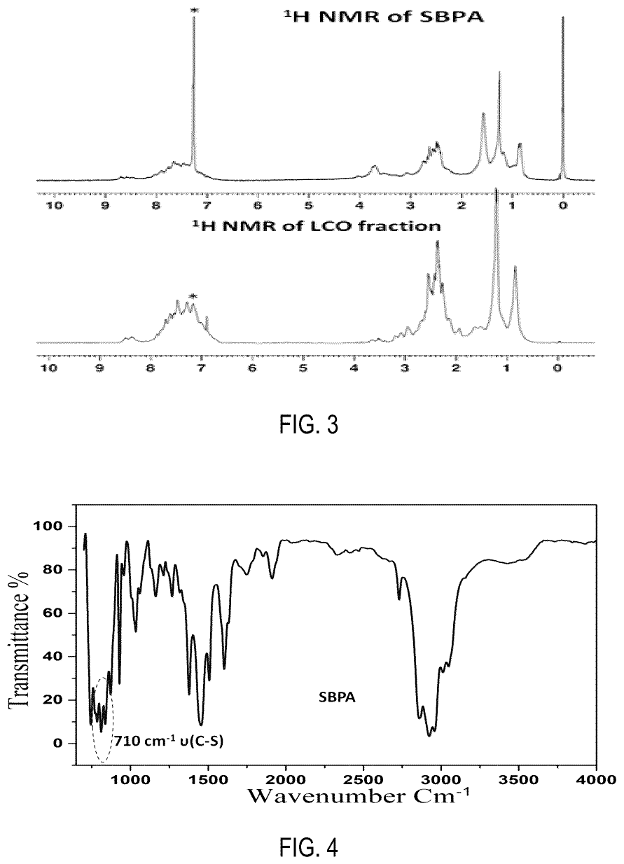

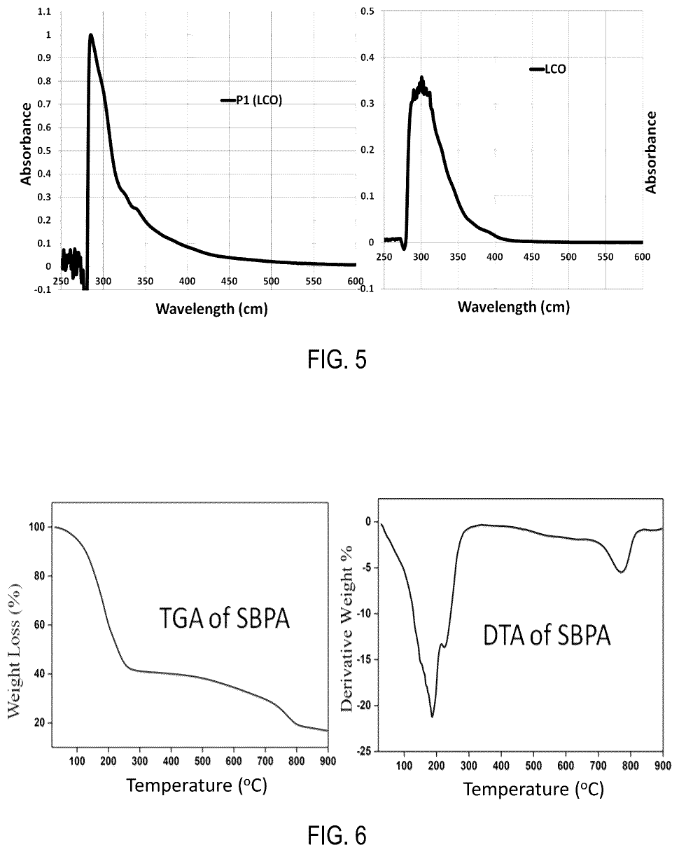

The SBPA was physico-chemically characterized for sulfur content and melting point. The additive was also characterized for ¹H NMR (FIG. 3), FT-IR (FIG. 4), UV (FIG. 5), and TGA (FIG. 6) The SBPA melting point was observed to be 140-160° C. The prepared additives have a solubility of ≥99% in TCE solvent.

### Characterization of Base Bitumen and Higher-Grade VG Bitumen for Basic Properties

a. Penetration

Base bitumen (VG10) and higher-grade VG bitumens were characterized for basic physical properties per standard ASTM test procedures ASTM D-05. First, the bitumen sample is heated to 90° C., then transferred to the moulds, kept for two hours at room temperature, and kept inside the water bath at 25±1° C. for 3 hours. When the bitumen sample achieved the test temperature, the first reading was taken at the center, and four other readings were taken at different positions around the center point of the penetration cup. The average of all the similar readings is considered a ‘PEN’ of the bitumen sample.

b. Softening Point

SP of bitumen is determined by the standard ASTM test method ASTM D 36. First, the bitumen sample is heated to 90° C., transferred to the rings, and kept inside the cooling bath. The temperature of the cooling bath was maintained at a temperature of 5±1° C. As per the ASTM test method, the sample was heated at a heating rate of 4-5° C. When steel balls with bitumen touches the base plate of the assembly, the temperature was recorded and mentioned as the softening point of the bitumen sample.

c. Kinematic Viscosity

KV of the bitumen sample was determined as per the standard test method ASTM D 2170. First, the bitumen sample is heated gently to avoid overheating until it becomes sufficiently soft. The melted sample was poured into the reverse flow (RF) viscometer and then kept inside the viscometer bath at a temperature of 135° C. Kinematic viscosity (KV) was the product of the time taken to flow the material in the viscometer to the calibration factor of the viscometer as per the ASTM test procedure.

d. Characterization of the Base Bitumen

The detailed physicochemical characterization of base bitumen (VG10) is shown in Table 1. As per ASTM test procedures, base bitumen was characterized for PEN, SP, KV, and PI. PI is the reflectance of temperature susceptibility of a bituminous binder. The higher the penetration index lesser is the temperature susceptibility of bitumen. Pfeiffer J P H and P M Van Doormall developed a nomograph to calculate the PI of a bituminous binder.

TABLE 1
Physical characterization of base bitumen VG10

| | | | KV @135° | |
|---|---|---|---|---|
| Characteristics | PEN, dmm | SP, ° C. | C., cSt | PI |
| Base Bitumen (VG10) | 110 | 38 | −402 | −3.04 |

### Characterization of the Synthesized VG Bitumens

Higher-grade VG bitumens were prepared as per Scheme 1. The prepared higher grade VG bitumens (VG+SBPA (0.1-20 wt %)) from low sulfur LCO and LCGO were characterized for PEN, SP, KV, and PI. The effect of the concentration of SBPA on these properties can be seen in Table 2. The prepared higher grade VG bitumens (VG+SBPA (0.1-20 wt %)) from high sulfur LCO were characterized for PEN, SP, KV, and PI. The effect of the concentration of SBPA on these properties can be seen in Table 3.

### Effect of Concentration of SBPA on the Base Bitumen

To optimize its digestive dose, the synthesized SBPA was used with VG10 base bitumen in the concentration range of 0.1 to 20 wt %. The detailed characterization of the effect of the concentration of SBPA can be seen in Table 2. VG10 bitumen was used as base bitumen for the study as it has the potential to dissolve or disperse the sulfur-based polymeric additive to make higher-grade VG bitumen.

PEN Vs. Concentration of SBPA

PEN is one of the fundamental properties used to determine the bitumen grade and measure the bitumen's consistency. It is defined as the degree of softness of a bituminous binder. The greater the bitumen penetration, the softer the bitumen, and conversely lesser the penetration and harder the bitumen. As per BIS specification, four grades of VG bitumens are generally used according to climatic conditions and roadside traffic load. It is determined as per ASTM D5/D5M-20 test procedures. Experimental results showed that 1.0 wt % SBPA (from LCO refinery stream LCO) meets VG20 specification and 2.5 wt % SBPA (from LCO refinery stream) meets VG30 and VG40 bitumen specification as per BIS specification IS:73:2013.

$$SAMB 9 = VG 10 + 2.5 wt \% LCO$$

$$SAMB 11 = VG 10 + 1. wt \% LCO$$

| Characteristics | VG10 | VG20 | VG30 | VG40 | SMB11 | SAMB9 |
|---|---|---|---|---|---|---|
| PEN, 25° C., | 80 | 60 | 45 | 35 | 63 | 45 |
| dmm, min | | | | | | |

This table shows that the PEN of SMB11 meets the penetration of VG20 bitumen while SAMB9 meets the specification of VG30 and VG40, both grade bitumens.

SP Vs. Concentration of SBPA

SP is also a primary test used as the consistency test for bituminous binders. SP is one of the fundamental properties used to determine the grade of the bitumen and is a measure of the consistency of bitumen. It is defined as a bituminous binder's degree of softness or hardness. The greater the softening point of bitumen harder the bitumen, and conversely lesser the SP, the softer is the bitumen. As per BIS specification, four grades of VG bitumens are generally used according to climatic conditions and roadside traffic load. It is determined as per ASTM D36-95 test procedure. In all four experiments, it can be seen that 5.0 wt % SBPA meets the VG20 specification of bitumen as per BIS specs IS:73:2013.

| | | | | | SAMB | |
|---|---|---|---|---|---|---|
| Characteristics | VG10 | VG20 | VG30 | VG40 | 11 | SAMB9 |
| SP, ° C. | 40 | 45 | 47 | 50 | 41 | 51 |

This table shows that softening point of SMB11 meets the PEN of VG20 bitumen while SAMB9 meets the specification of VG30 and VG40, both grade bitumens.

KV Vs. Concentration of SBPA

KV is the flow property of bitumen and is used to determine the grade of the bitumen. Generally, bitumen is mixed with aggregates in a hot-mix plant at 135° C., and thus it is determined at 135° C. As per BIS specification, four grades of VG bitumens are generally used to make flexible pavement. The selection of the grade of VG bitumen depends on the climatic condition and traffic load on the roadside. It defines whether the bitumen is sufficiently soft to mix with aggregates at this temperature or not and enables the uniformly mixing of bitumen with aggregates, and provides strength to the bitumen. It is determined as per ASTM D2170/D2170M-10 test procedure.

In all four experiments, it can be seen that 5.0 wt % SBPA meets the VG20 specification of bitumen as per BIS specs IS:73:2013.

| Character- | | | | | SAMB | |
|---|---|---|---|---|---|---|
| istics | VG10 | VG20 | VG30 | VG40 | 11 | SAMB9 |
| KV, 135° C., | 250 | 300 | 350 | 400 | 345 | 880 |
| cSt, min | | | | | | |

This table shows that the KV of SMB11 meets the PEN of VG20 bitumen while SAMB9 meets the specification of VG30 and VG40, both grade bitumens.

A graphical representation of the effect of concentration of SBPA (from high sulfur LCO refinery stream) higher grade bitumen on basic properties can be seen in FIG. 1.

PI Vs. Concentration of SBPA

PI refers to the temperature susceptibility of the bituminous binder. The greater the PI of the bitumen lesser is the temperature susceptibility of the bitumen, i.e., bitumen property deteriorates less with temperature. It is also an indication of high-quality bituminous property. As per BIS specification, four grades of VG bitumens are generally used according to climatic conditions, and traffic loads on the roadside having PI are listed in the table.

| | | | | | SAMB | |
|---|---|---|---|---|---|---|
| Characteristics | VG10 | VG20 | VG30 | VG40 | 11 | SAMB9 |
| PI | −3.07 | −2.13 | −2.18 | −1.93 | −1.44 | −1.18 |

This table shows the PI range of VG bitumens. It can be seen from this table that SAMB11 and SAMB 9 both have high PI and thus are less temperature susceptible.

Graphical representation of PI Vs. the effect of the concentration of SBPA (from high sulfur LCO refinery stream) higher grade bitumen can be seen in FIG. 2.

### EXAMPLES

The following examples are given by way of illustration and therefore should not be construed to limit the scope of the appended claims.

### Example 1

2.5 wt % of SBPA (from low sulfur LCO refinery stream) was blended with base bitumen to make higher-grade VG bitumen. An initially calculated amount 146.25 g of base bitumen (VG10) was taken in a round bottom flask and heated up to 100° C. 3.75 g of synthesized SBPA was added. The whole mixture was thermally agitated to 140° C. with stirring for 1 hour. The heating rate was maintained at 2° C. per minute with the help of a temperature controller.

After 1 hour, the sample was kept at room temperature (25° C.) for 24 hours for chilling and then tested for PEN at 25° C. as per the ASTM D05 standard test procedure, SP ASTM D36 standard test procedure, and KV at 135° C. as per ASTM D2170 standard test procedure. The prepared sample was also analyzed for PI. The same approach was used for all examples 2-9. The results are given in Table 2.

### Example 2

5.0 wt % of SBPA (from low sulfur LCO refinery stream) was blended with base bitumen to make higher-grade VG bitumen of higher grade. An initially calculated amount 142.50 g of base bitumen (VG10) was taken in a round bottom flask and heated up to 100° C. 7.5 g of synthesized SBPA was added. The whole mixture was thermally agitated to 140° C. with stirring for 1 hour. The heating rate was maintained at 2° C. per minute with the help of a temperature controller.

After 1 hour, the sample was kept at room temperature (25° C.) for 24 hours for chilling and then tested for PEN at 25° C. as per the ASTM D05 standard test procedure, SP ASTM D36 standard test procedure, and KV at 135° C. as per ASTM D2170 standard test procedure. The prepared sample was also analyzed for PI. The results are given in Table-2.

### Example 3

5.0 wt % of SBPA (from low sulfur LCGO refinery stream) was blended with base bitumen to make higher-grade VG bitumen of higher grade. An initially calculated amount 142.50 g of base bitumen (VG10) was taken in a round bottom flask and heated up to 100° C. 7.5 g of synthesized SBPA was added. The whole mixture was thermally agitated to 140° C. with stirring for 1 hour. The heating rate was maintained at 2° C. per minute with the help of a temperature controller.

After 1 hour, the sample was kept at room temperature (25° C.) for 24 hours for chilling and then tested for PEN at 25° C. as per the ASTM D05 standard test procedure, SP ASTM D36 standard test procedure, and KV at 135° C. as per ASTM D2170 standard test procedure. The prepared sample was also analyzed for PI. The results are given in Table 2.

TABLE 2
SBPA (from low sulfur LCO refinery stream)
and SBPA (from low sulfur LCGO refinery stream)
higher grade VG bitumen characteristics

| | | Characteristics | | | |
|---|---|---|---|---|---|
| | | PEN, | Softening | KV | |
| | | 25° C., | Point, | @135°C., | |
| Sample | | dmm | ° C. | cSt | PI |
| VG10 (min) | As per BIS | 80 | 40 | 250 | −3.07 |
| VG20 (min) | Specs | 60 | 45 | 300 | −2.13 |
| VG30 (min) | IS73: 2013 | 45 | 47 | 350 | −2.18 |
| VG40 (min) | | 35 | 50 | 400 | −1.93 |

| | | | | |
|---|---|---|---|---|
| VG10 (Base bitumen) | 110 | 38 | 402 | −3.04 |

Feed: SBPA from low sulfur LCO

| | | | | |
|---|---|---|---|---|
| VG10 + 2.5 wt % SBPA | 71 | 40 | 533 | −3.34 |
| VG10 + 5.0 wt % SBPA | 56 | 45 | 691 | −2.28 |

Feed: SBPA from low sulfur LCGO

| | | | | |
|---|---|---|---|---|
| VG10 + 5.0 wt % SBPA | 63 | 44 | 650 | −2.31 |

*min indicates the minimum value of the property

### Example 4

0.1 wt % of SBPA (from high sulfur LCO refinery stream) was blended with base bitumen to make higher grade VG bitumen of higher grade. An initially calculated amount 149.85 g of base bitumen (VG10) was taken in a round bottom flask and heated up to 100° C. 0.15 g of synthesized SBPA (from the LCO refinery stream) was added. The whole mixture was thermally agitated to 140° C. with stirring for 1 hour. The heating rate was maintained at 2° C. per minute with the help of a temperature controller.

After 1 hour, the sample was kept at room temperature (25° C.) for 24 hours for chilling and then tested for PEN at 25° C. as per the ASTM D05 standard test procedure, SP ASTM D36 standard test procedure, and KV at 135° C. as per ASTM D2170 standard test procedure. The prepared sample was also analyzed for PI. The results obtained were out of BIS specifications.

### Example 5

0.5 wt % of SBPA (from high sulfur LCO refinery stream) was blended with base bitumen to make higher grade VG bitumen of higher grade. An initially calculated amount 149.25 g of base bitumen (VG10) was taken in a round bottom flask and heated up to 100° C. 0.75 g of synthesized SBPA was added. The whole mixture was thermally agitated to 140° C. with stirring for 1 hour. The heating rate was maintained at 2° C. per minute with the help of a temperature controller.

After 1 hour, the sample was kept at room temperature (23° C.) for 24 hours for chilling and then tested for PEN at 25° C. as per the ASTM D05 standard test procedure, SP ASTM D36 standard test procedure, and KV at 135° C. as per ASTM D2170 standard test procedure. The prepared sample was also analyzed for PI. The results are given in Table-3.

### Example 6

1.0 wt % of SBPA (from high sulfur LCO refinery stream) was blended with base bitumen to make higher grade VG bitumen of higher grade. An initially calculated amount 148.50 g of base bitumen (VG10) was taken in a round bottom flask and heated up to 100° C. 1.5 g of synthesized SBPA was added. The whole mixture was thermally agitated to 140° C. with stirring for 1 hour. The heating rate was maintained at 2° C. per minute with the help of a temperature controller.

After 1 hour, the sample was kept at room temperature (22° C.) for 24 hours for chilling and then tested for PEN at 25° C. as per the ASTM D05 standard test procedure, SP ASTM D36 standard test procedure, and KV at 135° C. as per ASTM D2170 standard test procedure. A prepared sample (SAMB 11 having composition VG10+1.0 wt % High Sulfur LCO) meeting VG20 specification as per IS 73: 2013 was also analyzed for PI. The results are given in Table 3.

### Example 7

2.5 wt % of SBPA (from high sulfur LCO refinery stream) was blended with base bitumen to make higher grade VG bitumen of higher grade. An initially calculated amount 146.25 g of base bitumen (VG10) was taken in a round bottom flask and heated up to 100° C. 3.75 g of synthesized SBPA was added. The whole mixture was thermally agitated to 140° C. with stirring for 1 hour. The heating rate was maintained at 2° C. per minute with the help of a temperature controller.

After 1 hour, the sample was kept at room temperature (25° C.) for 24 hours for chilling and then tested for PEN at 25° C. as per the ASTM D05 standard test procedure, SP ASTM D36 standard test procedure, and KV at 135° C. as per ASTM D2170 standard test procedure. Prepared sample (SAMB 9 having composition VG10+2.5 wt % High Sulfur LCO) meeting VG30 and VG40 specifications as per IS 73: 2013 was also analyzed for PI. The results are given in Table 3.

### Example 8

5.0 wt % of SBPA (from high sulfur LCO refinery stream) was blended with base bitumen to make higher grade VG bitumen of higher grade. An initially calculated amount 142.50 g of base bitumen (VG10) was taken in a round bottom flask and heated up to 100° C. 7.5 g of synthesized SBPA was added. The whole mixture was thermally agitated to 140° C. with stirring for 1 hour. The heating rate was maintained at 2° C. per minute with the help of a temperature controller.

After 1 hour, the sample was kept at room temperature (25° C.) for 24 hours for chilling and then tested for PEN at 25° C. as per the ASTM D05 standard test procedure, SP ASTM D36 standard test procedure, and KV at 135° C. as per ASTM D2170 standard test procedure. The prepared sample was also analyzed for PI. The results are given in Table 3.

TABLE 3
SBPA (SBPA from high sulfur LCO) higher
grade VG bitumen characteristics

| | | Characteristics | | | |
|---|---|---|---|---|---|
| | | PEN, 25° | SP, | KV @135° | |
| Sample | | C., dmm | ° C. | C., cSt | PI |
| VG10 (min) | As per | 80 | 40 | 250 | −3.07 |
| VG20 (min) | BIS Specs | 60 | 45 | 300 | −2.13 |
| VG30 (min) | IS73: 2013 | 45 | 47 | 350 | −2.18 |
| VG40 (min) | | 35 | 50 | 400 | −1.93 |

| | | | | |
|---|---|---|---|---|
| VG10 (Base bitumen) | 110 | 38 | 402 | −3.04 |

Feed: SBPA from high sulfur LCO refinery stream

| | | | | |
|---|---|---|---|---|
| VG10 +0.5 wt % SBPA | 72 | 41 | 345 | −2.97 |
| VG10 +1.0 wt % SBPA | 63 | 47 | 652 | −1.44 |
| (SAMB11) | | | | |
| VG10 +2.5 wt % SBPA | 45 | 51 | 880 | −1.18 |
| (SAMB9) | | | | |
| VG10 +5.0 wt % SBPA | 22 | 68.5 | * | 0.73 |

*min indicates the minimum value of the property

### Example 9

20.0 wt % of SBPA (from high sulfur LCO refinery stream) was blended with base bitumen to make higher grade VG bitumen of higher grade. An initially calculated amount 120 g of base bitumen (VG10) was taken in a round bottom flask and heated up to 100° C. 30 g of synthesized SBPA was added. The whole mixture was thermally agitated to 140° C. with stirring for 1 hour. The heating rate was maintained at 2° C. per minute with the help of a temperature controller. After 1 hour, the sample was kept at room temperature (25° C.) for 24 hours for chilling and then tested for PEN at 25° C. as per the ASTM D05 standard test procedure, SP ASTM D36 standard test procedure, and KV at 135° C. as per ASTM D2170 standard test procedure. The prepared sample was also analyzed for PI. The results obtained were out of BIS specifications.

### Example 10

0.5 wt % of SBPA (from high sulfur LCO refinery stream) was blended with base bitumen to make higher grade VG bitumen. A calculated amount 149.25 g of base bitumen (VG10) was taken in a round bottom flask and heated up to 100° C. To this, 0.75 g of synthesized SBPA was added. The mixture was heated to 140° C. with stirring for 1 hour. The heating rate was maintained at 2° C. per minute with the help of a temperature controller. To further improve the properties of SBPA blended bitumen, 0.5 wt % of crumb rubber was added to it, and the mixture was maintained at 140° C. under stirred conditions for further 1 hour. The sample was kept at room temperature (25° C.) for 24 hours for chilling. The sample was tested for PEN at 25° C. per the ASTM D05 standard test procedure, SP ASTM D36 standard test procedure, and KV at 135° C. as per ASTM D2170 standard test procedure. The results are shown in Table 4 and failed to meet BIS specifications.

### Example 11

1.0 wt % of SBPA (from high sulfur LCO refinery stream) was blended with base bitumen to make higher grade VG bitumen. A calculated amount 148.50 g of base bitumen (VG10) was taken in a round bottom flask and heated up to 100° C. To this 1.5 g of synthesized SBPA was added. The mixture was heated to 140° C. with stirring for 1 hour. The heating rate was maintained at 2° C. per minute with the help of a temperature controller. To further improve the properties of SBPA, blended bitumen, 0.5 wt % of SBS was added to it. This mixture was maintained at 140° C. for under agitated conditions for further 1 hour. The sample was kept at room temperature (25° C.) for 24 hours for chilling. The sample was tested for PEN at 25° C. per the ASTM D05 standard test procedure, SP ASTM D36 standard test procedure, and KV at 135° C. as per ASTM D2170 standard test procedures. The results are shown in Table 4 and failed to meet BIS specifications.

TABLE 4
Effect of concentration of crumb rubber
and SBS on SBPA higher grade VG bitumen

| | | | VG10 + | | | |
|---|---|---|---|---|---|---|
| | | | (0.5 wt %) | VG10 + | | |
| | | | SBPA + | (1.0 wt %) | | |
| | VG10 | VG10 + | 0.5 wt % | SBPA + | | |
| | Base | (0.5 wt %) | crumb | (0.5 wt %) | VG30 | VG40 |
| Characteristics | Bitumen | SBPA | rubber | SBS | Specs | Specs |
| PEN, 25° C., dmm | 110 | 72 | 22 | 31 | 45 | 35 |
| SP, ° C. | 38 | 41 | 50 | 48 | 47 | 50 |
| KV@135° C., cSt | 402 | 345 | 972 | * | 350 | 400 |

* indicates the KV could not be determined at this temperature

SBPA has been prepared from crude oil and other petroleum refinery streams, which help in the desulfurization of these streams and provides the industrial applications of SBPA in bitumen modifications.

A viable approach has been provided for the preparation of high-quality higher, grade VG bitumens

Preparation processes have been provided for a less temperature susceptible higher-grade VG bitumens than equivalent conventional VG bitumen as adding SBPA at a particular concentration improves its PI.

What is claimed is:

1. A process for the preparation of higher-grade VG bitumens, the process comprising:
blending from 80 wt % to 99.90 wt % base bitumen and from 0.1 wt % to 20 wt % Sulfur-Based Polymeric Additives (SBPA) at a temperature from 100° C. to 140° C. with stirring at 800 rpm to 1200 rpm for 30 minutes to 90 minutes to obtain a blend; and
chilling the blend at from 15° C. to 25° C. for 12 hours to 24 hours to obtain higher-grade VG bitumens.

2. The process according to claim 1, wherein the base bitumen is VG10 bitumen or bitumen having properties similar to a bitumen of petroleum origin.

3. The process according to claim 1, wherein the SBPA is chosen from poly(thiophene-co-benzothiophene-co-dibenzothiophene) copolymers or sulfur-containing heterocyclic aromatic compounds.

4. The process according to claim 1, wherein SBPA is derived from a crude oil or a petroleum fraction as a viscous liquid to a semi-solid.

5. The process according to claim 1, wherein SBPA is derived LCO, LCGO, or HGO as a viscous liquid to a semi-solid.

6. The process according to claim 1, wherein SBPA is from 0.1 wt % to 20 wt % based on the total weight of the VG bitumen.

7. The process according to claim 1, wherein the SBPAs have molecular weights from 1000 Dalton to 10,000 Dalton; and wherein a kinematic viscosity of the higher-grade VG bitumen is from 200 cSt to 1000 cSt, measured at 135° C.
